(19) United States
(12) Patent Application Publication
(10) Pub. No.: US 2010/0154440 A1
(43) Pub. Date: Jun. 24, 2010

(54) RE-GASIFICATION OF LNG

(75) Inventors: Roy Inge Sørensen, Oslo (NO); Ellen Marie Kvam, Oslo (NO)

Correspondence Address: BIRCH STEWART KOLASCH & BIRCH, PO BOX 747, FALLS CHURCH, VA, 22040-0747, US

(73) Assignee: Moss Maritime AS, Lysaker (NO)

(21) Appl. No.: 12/516,735

(22) PCT Filed: Nov. 26, 2007
(86) PCT No.: PCT/NO2007/000417

§ 371 Date: Jun. 25, 2009

(30) Foreign Application Priority Data
Nov. 28, 2006 (NO) 2006 5472

(51) Int. Cl. F17C 9/02

(52) U.S. Cl. 62/50.2; 62/50.6

(57) ABSTRACT

The invention relates to a device for use in an LNG re-gasification system comprising a suction drum wherein said suction drum is sectionised by one or more baffles wherein said baffles are perforated. The invention further relates to a system and a process for use in re-gasification of LNG.

The present invention relates to a system for re-gasification of Liquefied Natural Gas, (LNG), and a device for use in said system. The system is useful both in an on- and off-shore facility.

Generally natural gas is produced from oil fields and natural gas fields.

Transportation of natural gas from the production fields to the place of consumption is a major challenge in the use of natural gas. Pipelines from the production fields to the end user are one route of transportation, but are not always practical and cost efficient. One way of transporting natural gas when pipelines from production fields are not available, is as LNG in vessels adapted for such transportation, e.g. cryogenic tankers. Transporting natural gas as LNG requires that the LNG is re-gasified before the consumption by the end-user. Re-gasification typically takes place at LNG receiving and re-gasification terminals which exists on-shore as well as off-shore.

In current re-gasification terminals, LNG is heated to pipeline specifications, typically 0-20° C. and 2-200 bar, in vaporizers. Any vaporizers may be used as long as they are effective to re-gasify LNG by heat exchange with a suitable heat exchange medium.

Examples of re-gasification systems can be found in e.g. WO-A1-2004/031644, WO-A2-2006/066015, U.S. Pat. No. 6,298,671 and U.S. Pat. No. 6,598,408.

In the present invention, a booster pump suction drum (BPSD) may be installed as a part of a re-gasification plant. The BPSD is installed between the storage tank pump and the booster pump to act as a buffer volume for normal flow changes, unexpected shut downs and to act as heat sink for the booster pump during start-up.

A basic product process flow involves transfer of LNG from storage tanks (2) to booster pumps (5) and vaporizers (6). The booster pumps increases the pressure to the level of the gas distribution network and the vaporizers transfers LNG to natural gas at the elevated pressure. The process, which is simplified shown in FIG. 1, also comprises a booster pump suction drum (4). LNG is supplied to the booster pump suction drum (4) from pumps (1) in the storage tank (2) and the LNG level in the suction drum (4) is kept constant by controlling the supply flow from the pump (1). The pressure in the BPSD will be a function of the flow to the booster pump and the head given by the pump in the storage tank. At normal flow rates the head of the storage tank pump will give a pressure between 2-8 bar a in the BPSD. Due to the pressure, the LNG in the BPSD will be supercooled and there will be no vapour phase which will be in equilibrium with the liquid phase of the LNG. Consequently, the pressure in the BPSD will tend to decrease, until equilibrium between liquid and vapour phase is reached, if no counter measures are taken. In order to maintain the pressure in the BPSD a blanket gas is introduced into the top of the drum. The blanket gas is typically a non-condensable gas such as nitrogen, but can also be natural gas vapour taken from a connection downstream of the vaporizer.

Calculations show that when nitrogen (N₂) is used as blanket gas, large quantities of N₂ is required to maintain the pressure in the BPSD when assuming equilibrium between the gas/vapour phase and the liquid phase at any point in the BPSD. This would require the installation of a high N₂ capacity generator to supply sufficient quantities of N₂. Further it may not be desirable to contaminate the natural gas delivered with large quantities of N₂.

The rate of absorption of N₂ into the LNG is dependent of several parameters, and with the mixing of the liquid phase inside the BPSD as an important one. Due to the flow of LNG through the BPSD this mixing will in general be extensive. According to the present invention, baffle(s) with relative small opening(s) is positioned a distance DL below the free surface, to substantially reduce this mixing and blanket gas consumption.

The present invention provides a device which reduces the blanket gas consumption. The device consists of one or more horizontal baffles (3) installed in the BPSD (4) below the normal liquid level. Each baffle (3) is furnished with one or more openings. Where more than one horizontal baffle are arranged, the openings in two neighbouring baffles are not directly opposite each other. The opening(s) in the baffle(s) ensures pressure communication between the blanket gas space and the supercooled LNG in the BPSD (4). Equilibrium between the gas/vapour phase and the liquid phase is restricted to a limited volume above the baffle(s) of the BPSD (4) rather than the whole BPSD volume. In this way an equilibrium pressure is maintained while at the same time the diffusion of blanket gas into the supercooled LNG is significantly reduced.

The opening(s) of the top baffle may optionally be fitted with a cap(s)that with a size bigger than the opening(s) in the baffle.

Blanket gas consumption is basically a governed by the size of the baffle plate opening, the liquid diffusion coefficient and the distance from the baffle plate up to the liquid surface. The mathematical expression for the blanket gas consumption is given as follows:

$${MolFlow}_{N 2} = {Area}_{Hole} \frac{{Deff}_{12 , N 2} \cdot {C}_{1 , N 2}}{DL \cdot ( 1 + \frac{{Area}_{Hole} \cdot {Deff}_{12 , N 2}}{DL \cdot {Q}_{LNG}} )}$$

Where
MolFlow_{N2} is the molar flow of N₂ through the BPSD (kmol/s)
Area_{Hole} is the area of opening in baffle (m²)
Deff_{12,N2} is the “effective” diffusion coefficient for N₂ in the liquid from the free surface to the baffle (m²/s)
C_{1,N2} is the molar density of N₂ in the liquid at the free surface (kmol/m³)
DL is the distance from the free surface to the baffle (m)
Q_{LNG} is the volumetric flow of LNG through the BPSD (m3/s)

When applying a opening in the baffle plate equal to 1/56 of the area of the tank, the typical reduction factor for the blanket gas consumption will be between 50 to 100 times the consumption without the baffle plate.

### BRIEF DESCRIPTION OF THE FIGURES

FIG. 1 shows a simplified presentation of a re-gasification process. Pump (1), LNG storage tank (2), baffle (3), suction drum (4), booster pump (5), vaporizer (6), pipeline—gas to consumer (7), pressure relief (8), blanket gas (9), booster pump recirculation line (10).

FIG. 2 shows a suction drum (4) with different baffle arrangements (3).

FIG. 3A shows a cap (11) arrangement over the opening of the top baffle (3).

FIG. 3B shows the section A-A

FIG. 3C shows section A-A from above, the cap (11) with means for attachment (12) of the cap to the baffle.

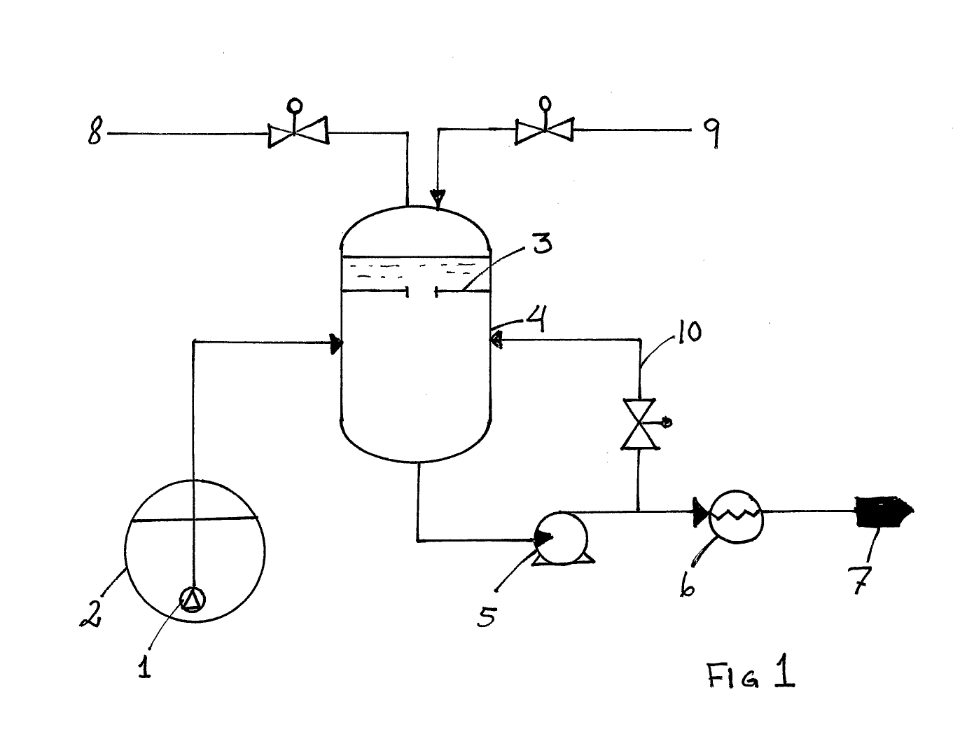

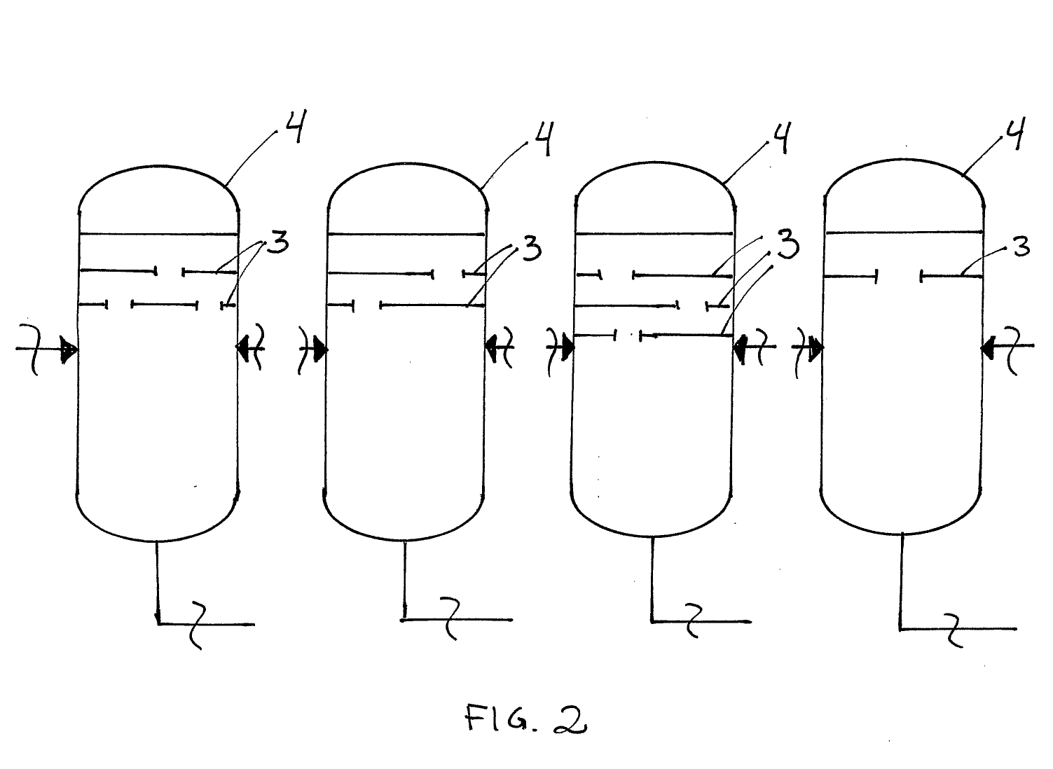

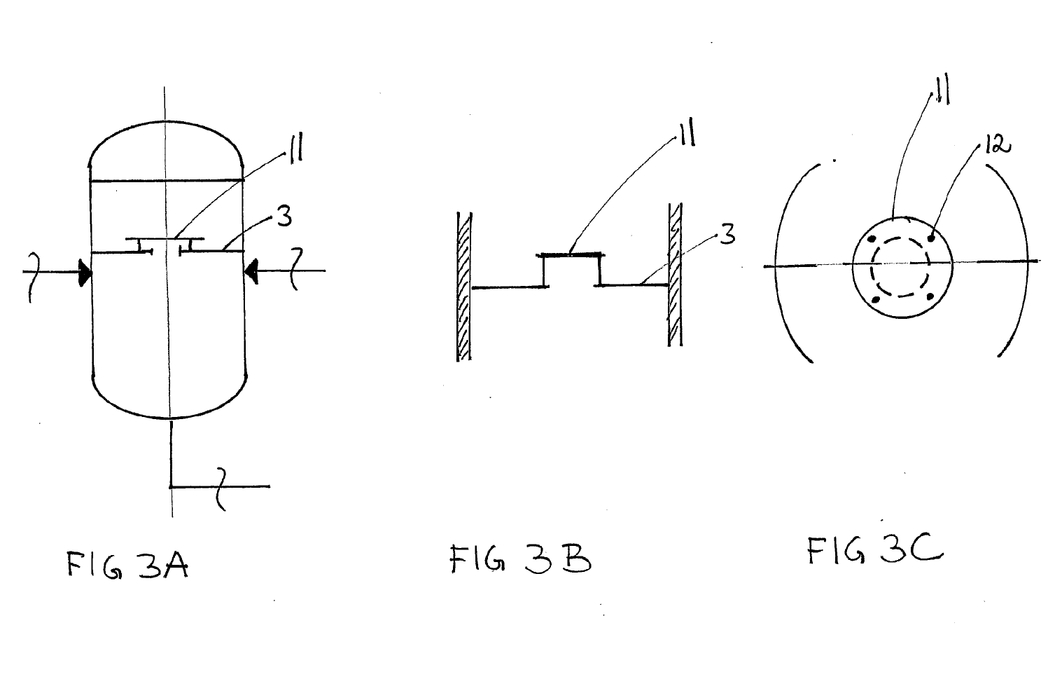

The following non-limiting examples illustrates an embodiment of the invention.

### EXAMPLE

Design parameters:

BSPD dimensions;

| | | |
|---|---|---|
| Volume: | 20.0 | m³ |
| Diameter: | 2.25 | m |
| Height: | 5.7 | m |

BSPD conditions:

| | |
|---|---|
| Temperature: | −157° C. (based on the temperature in the storage tank) |
| Pressure: | 4 and 7 bar a |

BPSD LNG:

The following LNG composition is selected since this will yield the lowest vapour pressure and the highest capacity for absorption of N₂ before reaching equilibrium state at the pressure an d temperature in the BPSD.

TABLE 1
Composition (mole %):

| | |
|---|---|
| N₂ | 0.20 |
| C1 (Methane) | 86.85 |
| C2 (Ethane) | 8.50 |
| C3 (Propane) | 3.00 |
| i-C4 (iso-butane) | 0.52 |
| n-C4 (n-butane) | 0.70 |
| C5+ (pentane and higher alkane) | 0.23 |
| Total | 100.00 |

LNG flow through the tank:

8-100%, (19-240 tons/h or 43-536 m³/h)

N₂ composition is for simplicity selected to be 100.00 mole %.

Full equilibrium is assumed for an infinitesimal layer of the vapour/liquid surface at the given pressure and temperature configurations.

Based on the equilibrium assumption, two dynamic simulations are done with different pressures where the BPSD, initially filled with N₂, are filled with LNG and the equilibrium composition is found. Results of simulations are shown below in tables 2 and 3.

TABLE 2
Case 1; Equilibrium at 7 bar a [mole %]

| | Nitrogen | Methane | Ethane | Propane | i-butane | n-butane | i-pentane | Water |
|---|---|---|---|---|---|---|---|---|
| Vapour | 0.8232 | 0.1767 | 0.0001 | 0.0000 | 0.0000 | 0.0000 | 0.0000 | 0.0000 |
| Liquid | 0.1826 | 0.7148 | 0.0700 | 0.0237 | 0.0048 | 0.0031 | 0.0009 | 0.0000 |

TABLE 3
Case 2: Equilibrium at 4 bar a [mole %]

| | Nitrogen | Methane | Ethane | Propane | i-butane | n-butane | i-pentane | Water |
|---|---|---|---|---|---|---|---|---|
| Vapour | 0.6821 | 0.3178 | 0.0001 | 0.0000 | 0.0000 | 0.0000 | 0.0000 | 0.0000 |
| Liquid | 0.0787 | 0.8057 | 0.0789 | 0.0267 | 0.0055 | 0.0035 | 0.0011 | 0.0000 |

A baffle with an opening is installed to decrease the contact area between the LNG and the LNG in equilibrium with nitrogen gas. The baffle minimizes mixing of the two liquids and thereby decreases further diffusion of nitrogen. In the calculations the opening is assumed circular and positioned in the centre of the baffle. The case where R_{HOLE}=1,125 m is without baffle.

| Molar weight | CH₄ | 16.04 | kg/kmol |
|---|---|---|---|
| | N₂ | 28.01 | kg/kmol |
| | LNG | 17.85 | kg/kmol |
| Viscosity, solvent | CH₄ | 0.1278 | cP (7 bar a) |
| | LNG | 0.1321 | cP (7 bar a) |
| Viscosity, solvent | CH₄ | 0.1023 | cP (4 bar a) |
| | LNG | 0.1320 | cP (4 bar a) |
| Temperature | | −157° C./116.15 K | |
| Molar volume | N₂ | 0.0312 | m³/kmol |
| | | 0.001113888 | m³/kg |

Tables 4 and 5 show the results of simulations with and without a baffle, with table 5 showing an extract of case 1B and case 2B from table 4. With the baffle the saving factor is 105 and 104.6 respectively with pressure of 7 and 4 bar a.

TABLE 4

| | | Case 1A/1B/1C = Marinteck memo | | | Same as Case 1 without baffle | | |
|---|---|---|---|---|---|---|---|
| | | Case 1A | Case 1B | Case 1C | Case 2A | Case 2B | Case 2C |
| R_{HOLE} | m | 0.15 | 0.15 | 0.15 | 1.125 | 1.125 | 1.125 |
| Area_{HOLE} | m2 | 0.07069 | 0.07069 | 0.07069 | 3.976 | 3.976 | 3.976 |
| C_{1,N2,7bara} | kmol/m3 | 4.011 | 4.011 | 4.011 | 4.011 | 4.011 | 4.011 |
| C_{1,N2,4bara} | kmol/m3 | 1.729 | 1.729 | 1.729 | 1.729 | 1.729 | 1.729 |
| C_{TotLiq} | kmol/m3 | 21.96 | | | 21.96 | | |
| Deff_{12,N2} | m2/s | 5.28E−08 | 5.00E−06 | 1.00E−03 | 5.28E−08 | 5.00E−06 | 1.00E−03 |
| DL | m | 0.372 | 0.372 | 0.372 | 0.2 | 0.2 | 0.2 |
| MW_{Liq} | kg/kmol | 20.26 | | | 20.26 | | |
| MW_{N2} | kg/kmol | 28 | | | 28 | | |
| LNG flow | m3/h | 536 | 536 | 536 | 536 | 536 | 536 |
| Q_{LNG} | m3/s | 0.149 | 0.149 | 0.149 | 0.149 | 0.149 | 0.149 |
| Rho_{LIQ} | kg/m3 | 445 | 445 | 445 | 445 | 445 | 445 |
| Rho_{N2} | kg/m3 @ 7bara & 15° C. | 8.18 | | | 8.18 | | |
| Rho_{N2} | kg/m3 @ 4bara & 15° C. | 4.68 | | | 4.68 | | |
| LNG mass flow | kg/h | 238520 | 238520 | 238520 | 238520 | 238520 | 238520 |
| M_{LNG} | kg/s | 66.26 | 66.26 | 66.26 | 66.26 | 66.26 | 66.26 |
| X_{1,N2,7bara} | — | 0.1826 | 0.1826 | 0.1826 | 0.1826 | 0.1826 | 0.1826 |
| X_{1,N2,4bara} | — | 0.0787 | 0.0787 | 0.0787 | 0.0787 | 0.0787 | 0.0787 |

${MolFlow}_{N 2} = {Area}_{Hole} \frac{{Deff}_{12 , N 2} \cdot {C}_{1 , N 2}}{DL \cdot ( 1 + \frac{{Area}_{Hole} \cdot {Deff}_{12 , N 2}}{DL \cdot {Q}_{LNG}} )}$

| MolFlow_{N2,7bara} | kmol/s | 4.024E−08 | 3.810E−06 | 7.611E−04 | 4.210E−06 | 3.984E−04 | 0.07034 |
|---|---|---|---|---|---|---|---|
| | kg/s | 1.127E−06 | 1.067E−04 | 0.02131 | 1.179E−04 | 1.116E−02 | 1.96958 |
| | kg/24 h | 0.097 | 9.218 | 1841.317 | 10.185 | 963.825 | 170171.54 |
| | m3/24 h | 0.012 | 1.127 | 225.100 | 1.245 | 117.827 | 20803.367 |
| | Present Case/Case 1 | | | | 104.6 | 104.6 | 92.4 |
| MolFlow_{N2,4bara} | kmol/s | 1.734E−08 | 1.642E−06 | 3.280E−04 | 1.814E−06 | 1.717E−04 | 3.032E−02 |
| | kg/s | 4.856E−07 | 4.598E−05 | 9.185E−03 | 5.081E−05 | 4.808E−03 | 8.489E−01 |
| | kg/24 h | 0.042 | 3.973 | 793.602 | 4.390 | 415.405 | 73343.375 |
| | m3/24 h | 0.005 | 0.486 | 97.017 | 0.537 | 50.783 | 8966.183 |
| | Case 2, 3, 4 divided in 1 | | | | 104.6243 | 104.5559 | 92.4184 |
| | 7bar/4bar | 2.3202 | 2.3202 | 2.3202 | 2.3202 | 2.3202 | 2.3202 |
| | | | | | 56.25 | 56.25 | 56.25 |
| | | Case 3A | Case 3B | Case 3C | Case 4A | Case 4B | Case 4C |
| R_{HOLE} | m | 0.15 | 0.15 | 0.15 | 0.15 | 0.15 | 0.15 |
| Area_{HOLE} | m2 | 0.07069 | 0.07069 | 0.07069 | 0.07069 | 0.07069 | 0.07069 |
| C_{1,N2,7bara} | kmol/m3 | 4.011 | 4.011 | 4.011 | 4.011 | 4.011 | 4.011 |
| C_{1,N2,4bara} | kmol/m3 | 1.729 | 1.729 | 1.729 | 1.729 | 1.729 | 1.729 |
| C_{TotLiq} | kmol/m3 | 21.96 | | | 21.06 | | |
| Deff_{12,N2} | m2/s | 5.28E−08 | 5.00E−06 | 1.00E−03 | 5.28E−08 | 5.00E−06 | 1.00E−03 |
| DL | m | 0.2 | 0.2 | 0.2 | 0.372 | 0.372 | 0.372 |
| MW_{Liq} | kg/kmol | 20.26 | | | 20.26 | | |
| MW_{N2} | kg/kmol | 28 | | | 28 | | |
| LNG flow | m3/h | 536 | 536 | 536 | 43 | 43 | 43 |
| Q_{LNG} | m3/s | 0.149 | 0.149 | 0.149 | 0.012 | 0.012 | 0.012 |
| Rho_{LIQ} | kg/m3 | 445 | 445 | 445 | 445 | 445 | 445 |
| Rho_{N2} | kg/m3 @ 7bara & 15° C. | 8.18 | | | 8.18 | | |
| Rho_{N2} | kg/m3 @ 4bara & 15° C. | 4.68 | | | 4.68 | | |
| LNG mass flow | kg/h | 238520 | 238520 | 238520 | 19135 | 19135 | 19135 |
| M_{LNG} | kg/s | 66.26 | 66.26 | 66.26 | 5.32 | 5.32 | 5.32 |
| X_{1,N2,7bara} | — | 0.1826 | 0.1826 | 0.1826 | 0.1826 | 0.1826 | 0.1826 |
| X_{1,N2,4bara} | — | 0.0787 | 0.0787 | 0.0787 | 0.0787 | 0.0787 | 0.0787 |

${MolFlow}_{N 2} = {Area}_{Hole} \frac{{Deff}_{12 , N 2} \cdot {C}_{1 , N 2}}{DL \cdot ( 1 + \frac{{Area}_{Hole} \cdot {Deff}_{12 , N 2}}{DL \cdot {Q}_{LNG}} )}$

| MolFlow_{N2,7bara} | kmol/s | 7.484E−08 | 7.087E−06 | 0.00141 | 4.024E−08 | 3.810E−06 | 0.00075 |
|---|---|---|---|---|---|---|---|
| | kg/s | 2.096E−06 | 1.984E−04 | 0.03960 | 1.127E−06 | 1.067E−04 | 0.02100 |
| | kg/24 h | 0.181 | 17.146 | 3421.100 | 0.097 | 9.218 | 1814.797 |
| | m3/24 h | 0.022 | 2.096 | 418.227 | 0.012 | 1.127 | 221.858 |
| | Present Case/Case 1 | 1.86 | 1.86 | 1.86 | 1.00 | 1.00 | 0.99 |
| MolFlow_{N2,4bara} | kmol/s | 3.226E−08 | 3.055E−06 | 6.095E−04 | 1.734E−08 | 1.642E−06 | 3.233E−04 |
| | kg/s | 9.032E−07 | 8.553E−05 | 1.707E−02 | 4.856E−07 | 4.598E−05 | 9.053E−03 |
| | kg/24 h | 0.078 | 7.390 | 1474.483 | 0.042 | 3.973 | 782.172 |
| | m3/24 h | 0.010 | 0.903 | 180.255 | 0.005 | 0.486 | 95.620 |
| | Case 2, 3, 4 divided in 1 | 1.8600 | 1.8600 | 1.8580 | 1.0000 | 0.9999 | 0.9856 |
| | 7bar/4bar | 2.3202 | 2.3202 | 2.3202 | 2.3202 | 2.3202 | 2.3202 |
| | | Case 5A | Case 5B | Case 5C | Case 6A | Case 6B | Case 6C |
| R_{HOLE} | m | 1.125 | 1.125 | 1.125 | 0.15 | 0.15 | 0.15 |
| Area_{HOLE} | m2 | 3.97608 | 3.97608 | 3.97608 | 0.07069 | 0.07069 | 0.07069 |
| C_{1,N2,7bara} | kmol/m3 | 4.011 | 4.011 | 4.011 | 5.491 | 5.491 | 5.491 |
| C_{1,N2,4bara} | kmol/m3 | 1.729 | 1.729 | 1.729 | 1.729 | 1.729 | 1.729 |
| C_{TotLiq} | kmol/m3 | 21.06 | | | 21.06 | | |
| Deff_{12,N2} | m2/s | 5.28E−08 | 5.00E−06 | 1.00E−03 | 5.28E−08 | 5.00E−06 | 1.00E−03 |
| DL | m | 0.05 | 0.05 | 0.05 | 0.372 | 0.372 | 0.372 |
| MW_{Liq} | kg/kmol | 20.26 | | | 20.26 | | |
| MW_{N2} | kg/kmol | 28 | | | 28 | | |
| LNG flow | m3/h | 536 | 536 | 536 | 536 | 536 | 536 |
| Q_{LNG} | m3/s | 0.149 | 0.149 | 0.149 | 0.149 | 0.149 | 0.149 |
| Rho_{LIQ} | kg/m3 | 445 | 445 | 445 | 445 | 445 | 445 |
| Rho_{N2} | kg/m3 @ 7bara & 15° C. | 8.18 | | | 8.18 | | |
| Rho_{N2} | kg/m3 @ 4bara & 15° C. | 4.68 | | | 4.68 | | |
| LNG mass flow | kg/h | 238520 | 238520 | 238520 | 238520 | 238520 | 238520 |
| M_{LNG} | kg/s | 66.26 | 66.26 | 66.26 | 66.26 | 66.26 | 66.26 |
| X_{1,N2,7bara} | — | 0.1826 | 0.1826 | 0.1826 | 0.25 | 0.25 | 0.25 |
| X_{1,N2,4bara} | — | 0.0787 | 0.0787 | 0.0787 | 0.0787 | 0.0787 | 0.0787 |

${MolFlow}_{N 2} = {Area}_{Hole} \frac{{Deff}_{12 , N 2} \cdot {C}_{1 , N 2}}{DL \cdot ( 1 + \frac{{Area}_{Hole} \cdot {Deff}_{12 , N 2}}{DL \cdot {Q}_{LNG}} )}$

| | | | | | | | |
|---|---|---|---|---|---|---|---|
| MolFlow_{N2,7bara} | kmol/s | 1.684E−05 | 1.590E−03 | 0.20790 | 5.509E−08 | 5.217E−06 | 1.042E−03 |
| | kg/s | 4.715E−04 | 4.453E−02 | 5.82117 | 1.543E−06 | 1.461E−04 | 0.02918 |
| | kg/24 h | 40.738 | 3847.599 | 502949.458 | 0.133 | 12.621 | 2520.971 |
| | m3/24 h | 4.980 | 470.367 | 61485.264 | 0.016 | 1.543 | 308.187 |
| | Present Case/Case 1 | 418.5 | 417.4 | 273.1 | 1.37 | 1.37 | 1.37 |
| MolFlow_{N2,4bara} | kmol/s | 7.258E−06 | 6.855E−04 | 8.960E−02 | 1.734E−08 | 1.642E−06 | 3.280E−04 |
| | kg/s | 2.032E−04 | 1.919E−02 | 2.509E+00 | 4.856E−07 | 4.598E−05 | 9.185E−03 |
| | kg/24 h | 17.558 | 1658.303 | 216769.564 | 0.042 | 3.973 | 793.602 |
| | m3/24 h | 2.146 | 202.726 | 26499.947 | 0.005 | 0.486 | 97.017 |
| | Case 2, 3, 4 divided in 1 | 418.4882 | 417.3880 | 273.1465 | 1.0000 | 1.0000 | 1.0000 |
| | 7bar/4bar | 2.3202 | 2.3202 | 2.3202 | 3.1766 | 3.1766 | 3.1766 |

| | | Case 7A | Case 7B | Case 7 [symbol] |
|---|---|---|---|---|
| R_{HOLE} | m | 0.1 | 0.1 | 0. [symbol] |
| Area_{HOLE} | m2 | 0.03142 | 0.03142 | 0.0314 [symbol] |
| C_{1,N2,7bara} | kmol/m3 | 5.491 | 5.491 | 5.49 [symbol] |
| C_{1,N2,4bara} | kmol/m3 | 1.729 | 1.729 | 1.72 [symbol] |
| C_{TotLiq} | kmol/m3 | 21.06 | | |
| Deff_{12,N2} | m2/s | 5.28E−08 | 5.00E−06 | 1.00E−0 [symbol] |
| DL | m | 0.372 | 0.372 | 0.37 [symbol] |
| MW_{Liq} | kg/kmol | 20.26 | | |
| MW_{N2} | kg/kmol | 28 | | |
| LNG flow | m3/h | 536 | 536 | 53 [symbol] |
| Q_{LNG} | m3/s | 0.149 | 0.149 | 0.14 [symbol] |
| Rho_{LIQ} | kg/m3 | 445 | 445 | 44 [symbol] |
| Rho_{N2} | kg/m3 @ 7bara & 15° C. | 8.18 | | |
| Rho_{N2} | kg/m3 @ 4bara & 15° C. | 4.68 | | |
| LNG mass flow | kg/h | 238520 | 238520 | 23852 [symbol] |
| M_{LNG} | kg/s | 66.26 | 66.26 | 66.2 [symbol] |
| X_{1,N2,7bara} | — | 0.25 | 0.25 | 0.2 [symbol] |
| X_{1,N2,4bara} | — | 0.0787 | 0.0787 | 0.078 [symbol] |
| ${MolFlow}_{N 2} = {Area}_{Hole} \frac{{Deff}_{12 , N 2} \cdot {C}_{1 , N 2}}{DL \cdot ( 1 + \frac{{Area}_{Hole} \cdot {Deff}_{12 , N 2}}{DL \cdot {Q}_{LNG}} )}$ | | | | |
| MolFlow_{N2,7bara} | kmol/s | 2.449E−08 | 2.319E−06 | 4.635E−0 [symbol] |
| | kg/s | 6.856E−07 | 6.492E−05 | 0.0129 [symbol] |
| | kg/24 h | 0.059 | 5.609 | 1121.2 |
| | m3/24 h | 0.007 | 0.686 | 137.06 [symbol] |
| | Present Case/Case 1 | 0.61 | 0.61 | 0.6 [symbol] |
| MolFlow_{N2,4bara} | kmol/s | 7.708E−09 | 7.299E−07 | 1.459E−0 [symbol] |
| | kg/s | 2.158E−07 | 2.044E−05 | 4.085E−0 [symbol] |
| | kg/24 h | 0.019 | 1.766 | 352.96 [symbol] |
| | m3/24 h | 0.002 | 0.216 | 43.14 [symbol] |
| | Case 2, 3, 4 divided in 1 | 0.4444 | 0.4444 | 0.444 [symbol] |
| | 7bar/4bar | 3.1766 | 3.1766 | 3.176 [symbol] |

[symbol]

indicates data missing or illegible when filed

TABLE 5

| | | (Case 1B) | (Case 2B) |
|---|---|---|---|
| | | Case 1 with | Case 2 without |
| | | baffle | baffle |
| R_{HOLE} | m | 0.15 | 1.125 |
| Area_{HOLE} | m2 | 0.07069 | 3.976 |
| C_{1, N2, 7bara} | kmol/m3 | 4.011 | 4.011 |
| C_{1, N2, 4bara} | kmol/m3 | 1.729 | 1.729 |
| C_{TotLiq} | kmol/m3 | | |
| Deff_{12, N2} | m2/s | 5.00E−06 | 5.00E−06 |
| DL | m | 0.372 | 0.2 |
| MW_{Liq} | kg/kmol | 20.26 | 20.26 |
| MW_{N2} | kg/kmol | 28 | 28 |
| LNG flow | m3/h | 536 | 536 |
| Q_{LNG} | m3/s | 0.149 | 0.149 |
| Rho_{LIQ} | kg/m3 | 445 | 445 |
| Rho_{N2} | kg/m3 @ 7bara & 15° C. | 8.18 | 8.18 |
| Rho_{N2} | kg/m3 @ 4bara & 15° C. | 4.68 | 4.68 |
| LNG mass flow | kg/h | 238520 | 238520 |
| M_{LNG} | kg/s | 66.26 | 66.26 |
| X_{1.N2, 7 bara} | — | 0.1826 | 0.1826 |
| X_{1.N2, 4 bara} | — | 0.0787 | 0.0787 |
| MolFlow_{N2, 7bara} | kmol/s | 3.810E−06 | 3.984E−04 |
| | kg/s | 1.067E−04 | 1.116E−02 |
| | kg/24 h | 9.218 | 963.825 |
| | m3/24 h | 1.127 | 117.827 |
| | Saving factor with baffle plate | | 105 |
| MolFlow_{N2, 4bara} | kmol/s | 1.642E−06 | 1.717E−04 |
| | kg/s | 4.598E−05 | 4.808E−03 |
| | kg/24 h | 3.973 | 415.405 |
| | m3/24 h | 0.486 | 50.783 |
| | Saving factor with baffle plate | | 104.6 |

1-8. (canceled)

9. A device for use in an LNG re-gasification system comprising a LNG storage tank supplying a suction drum with LNG5 a blanket gas source supplying blanket gas to the suction drum, a booster pump and a vaporizer, wherein said suction drum is sectionized by one or more baffles wherein said baffles are perforated.

10. The device according to claim 9, wherein said baffles are perforated by one or more opening.

11. The device according to claim 9, wherein the openings in neighboring baffles are placed such that they do not stand directly opposite each other.

12. The device according to claim 9, wherein the opening(s) of the top baffle is fitted with cap(s) with a size bigger than the opening(s) in said baffle.

13. A system for re-gasification of LNG comprising a LNG storage tank containing a pump supplying a suction drum with LNG, a blanket gas source supplying blanket gas to the top of the suction drum, a booster pump and a vaporizer, wherein said suction drum is sectionized by one or more baffles wherein said baffles are perforated.

14. The system according to claim 13, wherein said baffles are perforated by one or more opening.

15. The system according to claim 13, wherein the openings in neighboring baffles are placed such that they do not stand directly opposite each other.

16. A process for re-gasification of LNG, wherein:
a) LNG is pumped from an LNG storage tank to a suction drum
b) said suction drum is sectionized by one or more baffle and a non-condensable gas is added at the top of said suction drum to maintain pressure,
c) a booster pump increase the pressure to delivery level,
d) a vaporizer wherein the LNG is transferred to natural gas at said elevated pressure, and
e) natural gas at conventional temperature and pressure is delivered to pipeline.

17. The device according to claim 10, wherein the openings in neighboring baffles are placed such that they do not stand directly opposite each other.

18. The device according to claim 10, wherein the opening(s) of the top baffle is fitted with cap(s) with a size bigger than the opening(s) in said baffle.

19. The system according to claim 14, wherein the openings in neighboring baffles are placed such that they do not stand directly opposite each other.
